(19) United States
(12) Patent Application Publication
(10) Pub. No.: US 2026/0145622 A1
(43) Pub. Date: May 28, 2026

(54) ADJUSTABLE TIE-DOWN CRADLE FOR BICYCLE RACK

(71) Applicant: ALLEN GLOBAL FZCO, Dubai (AE)

(72) Inventors: Michael Joseph DESCHENE, Marblehead, MA (US); John D. FIEGENER, Marblehead, MA (US)

(73) Assignee: ALLEN GLOBAL FZCO, Dubai (AE)

(21) Appl. No.: 18/956,129

(22) Filed: Nov. 22, 2024

(51) Int. Cl. B60R 9/10

(52) U.S. Cl. CPC B60R 9/10

(57) ABSTRACT

An adjustable tie-down cradle for use with a vehicle bicycle rack is provided. The tie-down cradle includes an elongated support member, where the elongated support member is configured to be slidably received on a bicycle rack carrying arm of a bicycle rack. The tie-down cradle may also include a saddle configured to hold a bicycle frame tube of a bicycle, the saddle including a first saddle component coupled to the elongated support member, and a second saddle component coupled to the elongated support member. The first saddle component may slide linearly along a first axis of the elongated support member to adjust the size of the saddle to a bicycle frame tube. The second saddle component may be integrally molded to the elongated support member. A bicycle rack configured to hold a bicycle to a vehicle may be provided with an adjustable tie-down cradle. In one embodiment, the first and second saddle components can both move radially around a bicycle rack carrying arm of a bicycle rack to adjust the angular orientation of the tie-down cradle relative to the bicycle rack carrying arm. Methods of adjusting a tie-down cradle on a vehicle bicycle rack are also provided.

### FIELD OF THE INVENTION

This disclosure relates to bicycle rack, and more specifically, to a tie-down cradle for a vehicle bicycle rack.

### BACKGROUND

There are a variety of known types of bicycle racks for securing a bicycle to a vehicle. These racks are typically removably attached to a rear portion of the vehicle, either attached to the trunk or the hitch of the vehicle.

### SUMMARY

According to a first aspect, a bicycle rack configured to hold a bicycle to a vehicle is provided. The bicycle rack includes a bicycle rack carrying arm, and an adjustable tie-down cradle coupled to the bicycle rack carrying arm. The adjustable tie-down cradle includes an elongated support member slidably received on the bicycle rack carrying arm, the elongated support member having a first axis, and a saddle configured to hold a bicycle frame tube of a bicycle. The saddle includes a first saddle component coupled to the elongated support member, and a second saddle component coupled to the elongated support member. The first saddle component can slide linearly along the first axis of the elongated support member to adjust the size of the saddle to a bicycle frame tube, and the first and second saddle components can both move radially around the bicycle rack carrying arm to adjust the angular orientation of the tie-down cradle relative to the bicycle rack carrying arm.

According to another aspect, an adjustable tie-down cradle for use with a vehicle bicycle rack is provided. The tie-down cradle includes an elongated support member having a first axis, where the elongated support member is configured to be slidably received on a bicycle rack carrying arm of a bicycle rack. The tie-down cradle also includes a saddle configured to hold a bicycle frame tube of a bicycle. The saddle includes a first saddle component coupled to the elongated support member, and a second saddle component coupled to the elongated support member. The first saddle component can slide linearly along the first axis of the elongated support member to adjust the size of the saddle to a bicycle frame tube, and the second saddle component is integrally molded to the elongated support member.

According to yet another aspect, a method of adjusting a tie-down cradle on a vehicle bicycle rack is provided. The method includes providing a bicycle rack which includes a bicycle rack carrying arm, and providing an adjustable tie-down cradle on the bicycle rack carrying arm, the adjustable tie-down cradle including an elongated support member having a first axis and a saddle configured to hold a bicycle frame tube of a bicycle. The saddle includes a first saddle component coupled to the elongated support member, and a second saddle component coupled to the elongated support member. The method further includes sliding the first saddle component linearly along the first axis of the elongated support member to adjust the size of the saddle to a bicycle frame tube, and rotating the first and second saddle components radially around the bicycle rack carrying arm to adjust the angular orientation of the tie-down cradle relative to the bicycle rack carrying arm.

### BRIEF DESCRIPTION OF THE DRAWINGS

FIG. 1 is a first perspective view of an assembled bicycle rack according to one embodiment;

FIG. 2 is a second perspective view of an assembled bicycle rack according to one embodiment;

FIG. 3 is an exploded assembly view of a bicycle rack according to one embodiment;

FIG. 4 is a perspective view of an adjustable tie-down cradle according to one embodiment in a first position;

FIG. 5 is a perspective view of an adjustable tie-down cradle according to one embodiment in a second position;

FIG. 6 is an exploded assembly view of an adjustable tie-down cradle according to one embodiment;

FIG. 7 is a second exploded assembly view of an adjustable tie-down cradle according to one embodiment;

FIG. 8 is a perspective view of a bicycle rack according to one embodiment with a bicycle;

FIG. 9 is another perspective view of the bicycle rack and bicycle shown in FIG. 8;

FIG. 10 is a perspective view of a bicycle rack according to another embodiment shown with a bicycle; and

FIG. 11 is a perspective view of the bicycle rack shown in FIG. 10 with the first and second saddle components of the tie-down cradle moved radially around the bicycle rack carrying arm.

### DETAILED DESCRIPTION

The present disclosure is directed to a bicycle rack and a tie-down cradle for use with a vehicle bicycle rack. As set forth in more detail below, aspects of the present disclosure are directed to a bicycle rack which can be used to secure a wide variety of sized bicycles to a vehicle. Furthermore, as set forth in more detail below, aspects of the present disclosure are directed to an adjustable tie-down cradle that easily adjusts to the size (i.e., diameter) of a bicycle frame tube of a bicycle.

The present disclosure builds upon the technology disclosed in Applicant's earlier patents directed to vehicle bicycle racks which are discussed in U.S. Pat. No. 5,435,472 filed Jan. 25, 1994, U.S. Pat. No. 6,644,525 filed Jan. 29, 2002, U.S. Pat. No. 7,261,229 filed Apr. 28, 2004, U.S. Pat. No. 8,636,184 filed Oct. 15, 2010, and U.S. Pat. No. 11,878,658 filed Sep. 3, 2021, all of which are incorporated by reference herein in their entirety. These earlier patents disclose conventional vehicle bicycle racks technology and describe in detail some of the components of a bicycle rack.

The Applicant recognized that there was a need for a vehicle bicycle rack that can be used to secure different types of bicycles, including, but not limited to, kid sized bicycles, adult sized bicycles, road bikes, mountain bikes, and/or electric bicycles (i.e., e-bikes). In particular, Applicant recognized that there was a trend for transporting e-bikes on vehicles, and in general, the outer diameter of the bicycle frame tube of an e-bike is significantly larger than the outer diameter of a bicycle frame tube for a conventional road bike. For example, in one embodiment, the outer diameter of a bicycle frame tube for a conventional road bike may range from about 1.2 inches up to about 2 inches. In contrast, in one embodiment, the outer diameter of a bicycle frame tube for an e-bike may range from about 1.5 inches to about 4 inches. Accordingly, in one embodiment, the tie-down cradle can be adjusted to hold a bicycle frame with a diameter ranging from about 1 inch up to about 4 inches.

Accordingly, as set forth below, aspects of the present disclosure are directed to an adjustable tie-down cradle that includes at least one component that slides linearly relative to another component to adjust the size of the tie-down cradle. Applicant recognized that this was quite different from prior bicycle racks, some which have all stationary components, some which have jaw-like components that pivot relative to each other, and many which do not adjust to hold different sized bicycle frame tube diameters.

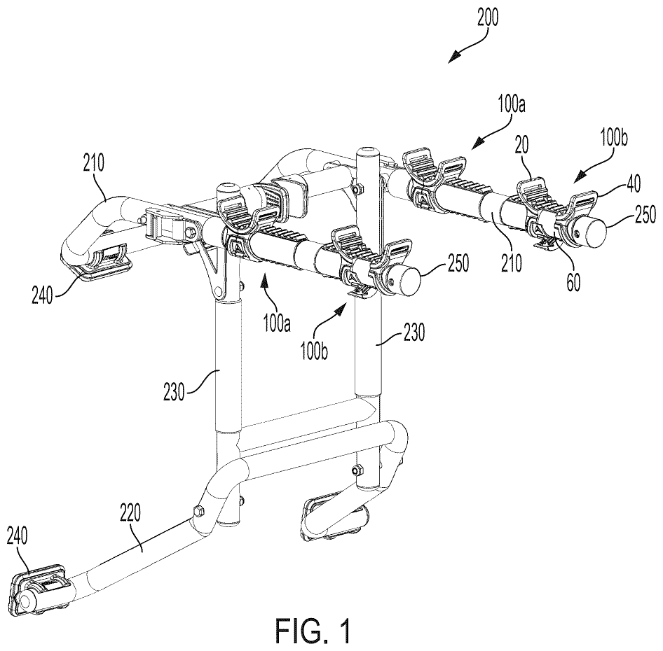

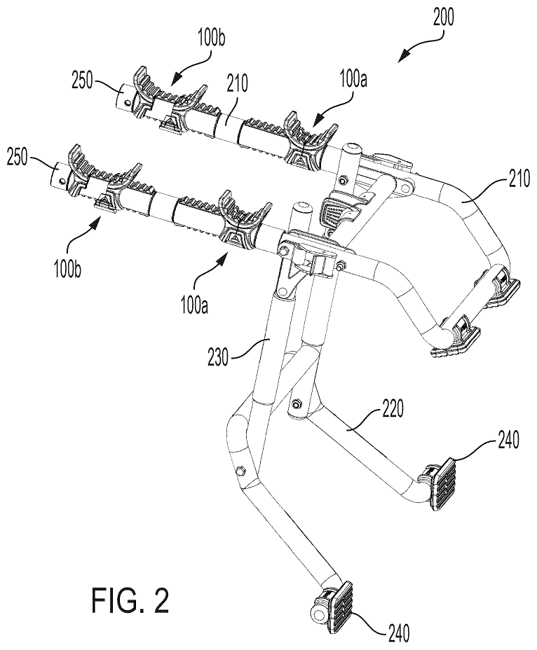

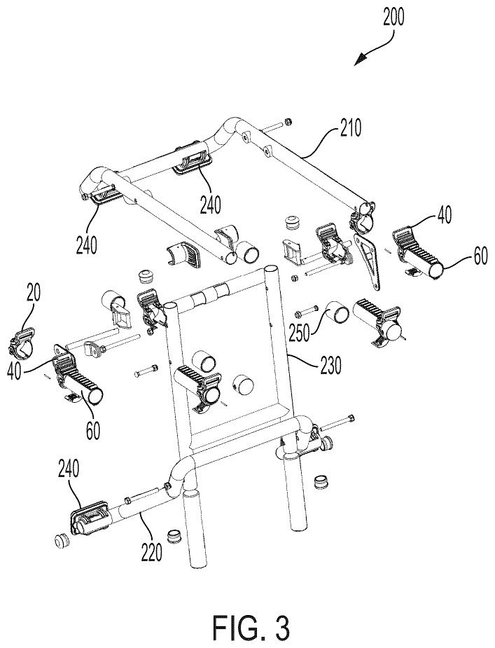

Turning now to the figures, FIGS. 1 and 2 illustrate two perspective views of an assembled bicycle rack 200 according to one embodiment, and FIG. 3 shows an exploded assembly view. As shown, the bicycle rack 200 includes at least one bicycle rack carrying arm 210, and as explained in more detail below, the bicycle rack 200 may include an adjustable tie-down cradle 100 coupled to the bicycle rack carrying arm 210. As shown, in one illustrative embodiment, the bicycle rack 200 includes a plurality of adjustable tie-down cradles 100a, 100b. For example, two adjustable tie-down cradles 100a may be sized to hold a bicycle frame tube having a first outer diameter, and two adjustable tie-down cradles 100b may be sized to hold a bicycle frame tube having a second outer diameter, where the second outer diameter is larger than the first outer diameter.

The specific structure of the bicycle rack 200 may vary according to different embodiments, but as shown in FIGS. 1 and 2, in one embodiment, the carrying arm 210 is a substantially U-shaped arm having a first end configured to hold one or more tie-down cradles 100a, 100b, and a second end configured to hold one or more tie-down cradles 100a, 100b. As further shown in FIGS. 1 and 2, the bicycle rack 200 may include a lower support frame 220, and a vertical support frame 230 may couple the carrying arm 210 to the lower support frame 220. As shown, the bicycle rack 200 may also include one or more feet/pads 240 which may be movable/rotatable on the carrying arm 210, the lower support frame 220 and/or the vertical support frame 230. One of ordinary skill in the art will appreciate that these feet/pads 240 may be configured to rest against the vehicle to protect the vehicle from being scratched and/or otherwise damaged by the bicycle and/or the rack 200 itself.

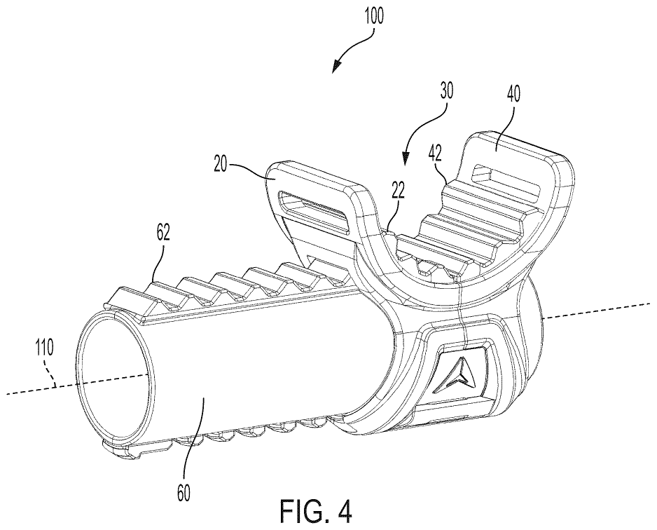

FIG. 4 illustrates one embodiment of an adjustable tie-down cradle 100 in more detail. As shown, the tie-down cradle 100 may include an elongated support member 60 having a first axis 110. As shown in FIGS. 1-3, the elongated support member 60 is slidably received on the bicycle rack carrying arm 210. As also shown in FIGS. 1-3, the bicycle rack 200 may include an end cap 250 on each of the two ends of the bicycle rack carrying arm 210. One of ordinary skill in the art would appreciate that the end caps 250 may need to be removed to slide the elongated support member 60 onto the carrying arm 210 and that the placement of the end caps 250 on the ends of the carrying arm 210 may also prevent any undesired movement of the tie-down cradle 100. It should be recognized that not every component shown in FIGS. 1-3 includes a reference number, and one of ordinary skill in the art will appreciate that many of the conventional components of the bicycle rack 200 may be outlined in one of the above-mentioned patents.

As shown in FIG. 4, the adjustable tie-down cradle 100 also includes a saddle 30 configured to hold a bicycle frame tube of a bicycle. In this embodiment, the saddle 30 includes a first saddle component 20 and a second saddle component 40, both coupled to the elongated support member 60. In one illustrative embodiment, the first and second saddle components 20, 40 together form a substantially C-shaped saddle shaped to hold a bicycle frame tube of a bicycle. In another embodiment, it is contemplated that the saddle 30 may have a different shape, such as, but not limited to U-shapes, V-shapes, and/or irregular shapes, oval shapes, square shapes, or two separate tubes in proximity are also contemplated, as the disclosure is not so limited. As set forth in more detail below, the tie-down cradle may also include a securing feature, such as a strap, which may, for example, extend from the first saddle component 20 to the second saddle component 40 and it may be tightened around the bicycle frame tube.

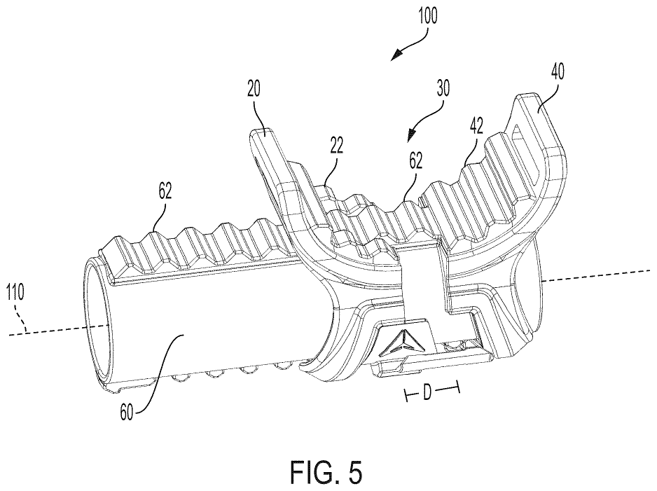

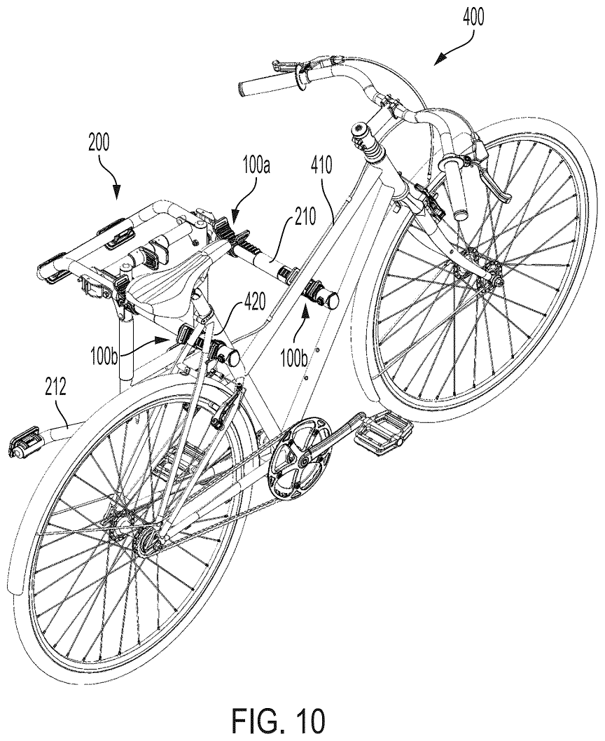

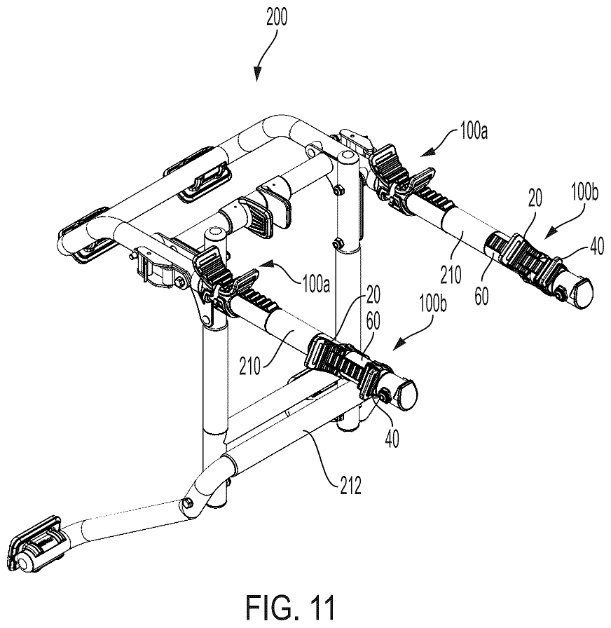

As shown in FIG. 5, the first saddle component 20 can slide linearly along the first axis 110 of the elongated support member 60 to adjust the size of the saddle 30 to a bicycle frame tube. Furthermore, as set forth in more detail below, and as shown in FIGS. 10-11, the first and second saddle components 20, 40 can both move radially around the bicycle rack carrying arm 210 to adjust the angular orientation of the tie-down cradle 100 relative to the bicycle rack carrying arm 210. One of ordinary skill in the art will appreciate that in the embodiment shown in FIG. 4, the saddle 30 may be sized for a first sized bicycle frame tube, whereas in the embodiment shown in FIG. 5, where the position of the first saddle component 20 has moved along the first axis 110, the saddle 30 may be sized for a second larger sized bicycle frame tube.

In one particular embodiment, the second saddle component 40 is integrally molded with the elongated support member 60. For example, in one embodiment, the second saddle component 40 and the elongated support member 60 may be injection molded together. Exemplary materials may include PVC (polyvinyl chloride), TPS plastic (thermoplastic styrene block copolymers), and/or various rubber materials. Because these parts are integrally formed, in this embodiment, the first saddle component 20 can slide relative to both the second saddle component 40 and the elongated support member 60.

Furthermore, as illustrated, in one embodiment, the elongated support member 60 is a cylindrical shaped tube. However, it should be appreciated that in another embodiment, the elongated support member may be configured differently, and may for example have other shapes, such as, but not limited to non-cylindrical shapes. It should be recognized that with a non-cylindrical shape, the tie-down cradle components, such as the first and second saddle components 20, 40 may not as readily rotate around a bicycle rack carrying arm to adjust the angular orientation of the tie-down cradle.

FIG. 4 illustrates an embodiment where the first saddle component 20 is adjacent to and contacting the second saddle component 40 which forms the smallest saddle 30 configuration. In contrast, FIG. 5 illustrates an embodiment where the first saddle component 20 is spaced apart from the second saddle component 40 by a distance D. One of ordinary skill in the art will appreciate that the distance D in FIG. 4 is substantially zero. In one embodiment, the first saddle component 20 may slide linearly along the elongated support member 60 such that the distance D ranges from about 0 to about 3 inches. In another embodiment, the first saddle component 20 may slide linearly along the elongated support member 60 such that the distance D ranges from about 0 to about 4 inches.

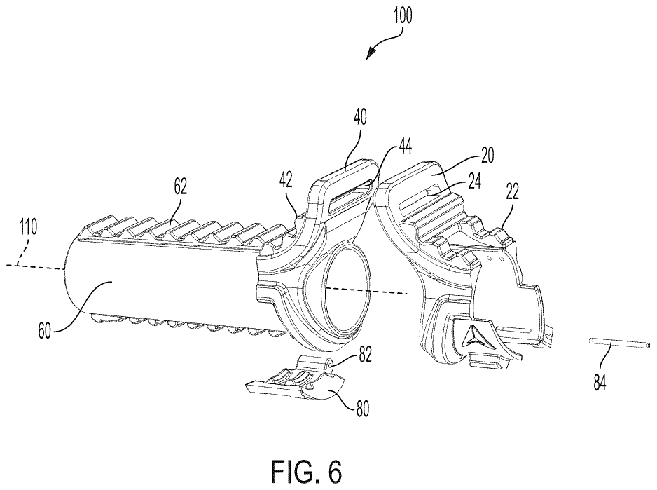

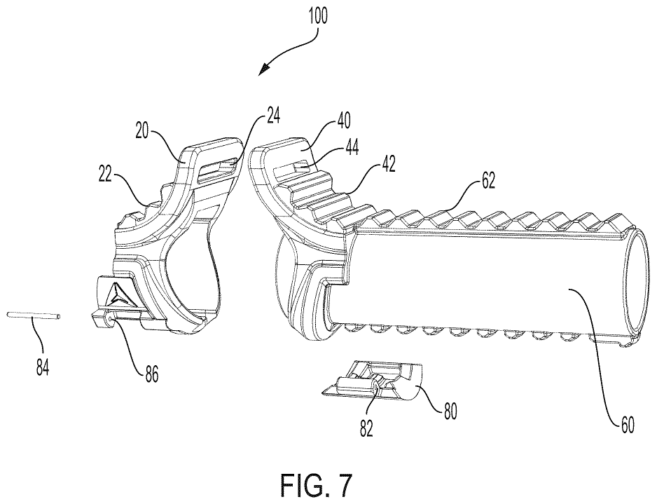

FIGS. 6 and 7 illustrate an exploded assembly view of an adjustable tie-down cradle 100 shown in FIGS. 4 and 5. As shown in FIGS. 6 and 7, in one embodiment, the first saddle component 20 may be configured to extend substantially around the elongated support member 60. As shown, the first saddle component 20 may be substantially ring shaped and configured to receive the elongated support member 60. Similarly, in one embodiment, the second saddle component 40 may also be configured to extend substantially around the elongated support member 60, and as shown, the second saddle component 40 may also be substantially ring shaped and configured to receive the elongated support member 60.

The tie-down cradle may also include a securing feature (not shown), such as, but not limited to a strap and buckle, or a rubber strap. As discussed in Applicant's above-mentioned earlier patents, which are all incorporated by reference in in their entirety, in one embodiment, one or more straps (or other type of securing feature) may be provided to secure a bicycle frame tube 310, 410, 420 to each cradle 100a, 100b. One of ordinary skill in the art will appreciate that the strap may be tightened around the bicycle frame tube to help secure the bicycle 300, 400 to the rack 200.

As shown in FIGS. 6 and 7, in one embodiment, the tie-down cradle 100 may include a locking mechanism 80 on the elongated support member 60, and the locking mechanism 80 may be configured to lock the position of the first saddle component 20 relative to the elongated support member 60. In one embodiment, the locking mechanism 80 may rotate about pivot axis 82 between a locked position and an unlocked position. One of ordinary skill in the art will appreciate that in one embodiment, in the locked position, the locking mechanism 80 may be flush with portions of the elongated support member 60, whereas in an unlocked position, the locking mechanism 80 may be rotated about pivot axis 82 away from the elongated support member 60.

As also shown in FIGS. 6 and 7, in one embodiment, the locking mechanism 80 may include portions located on the first saddle component 20, including for example, a pin 84 and a recess 86 on the first saddle component 20. When assembled, the pin 84 may rotate about pivot axis 82 on the locking mechanism 80, and the pin 84 may rotatably secure the locking mechanism 80 within the recess 86 on the first saddle component 20. It should be appreciated that the pin 84 may rotate about pivot axis 82.

In one embodiment, when the locking mechanism is in its unlocked position, a user can linearly slide the first saddle component 20 along the elongated support member 60 to adjust the size of the saddle 30. Once the first saddle component 20 is in a desired position, the locking mechanism 80 may be rotated into its locked position to prevent further movement of the first saddle component 20. It should be appreciated that this is one exemplary locking mechanism 80, and those of ordinary skill in the art will appreciate that other locking mechanisms may also be implemented, as the present disclosure is not so limited.

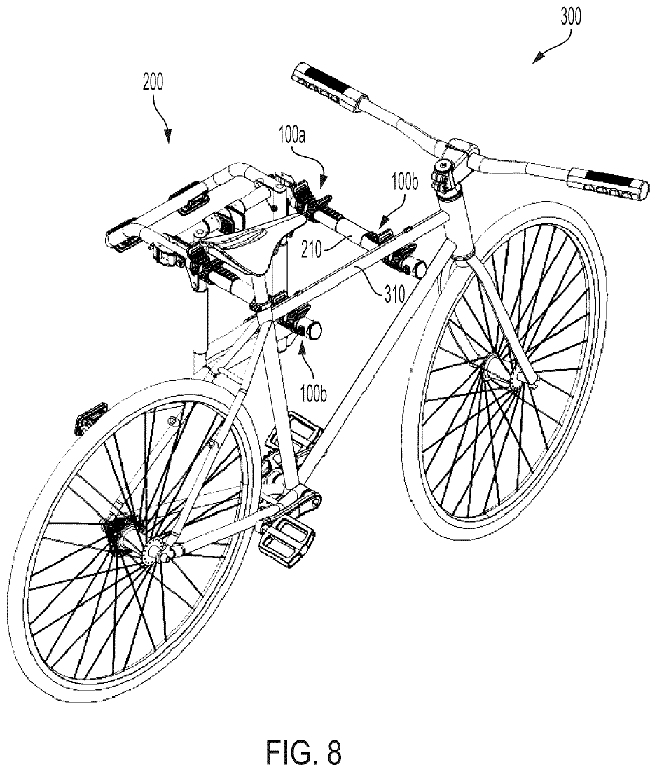

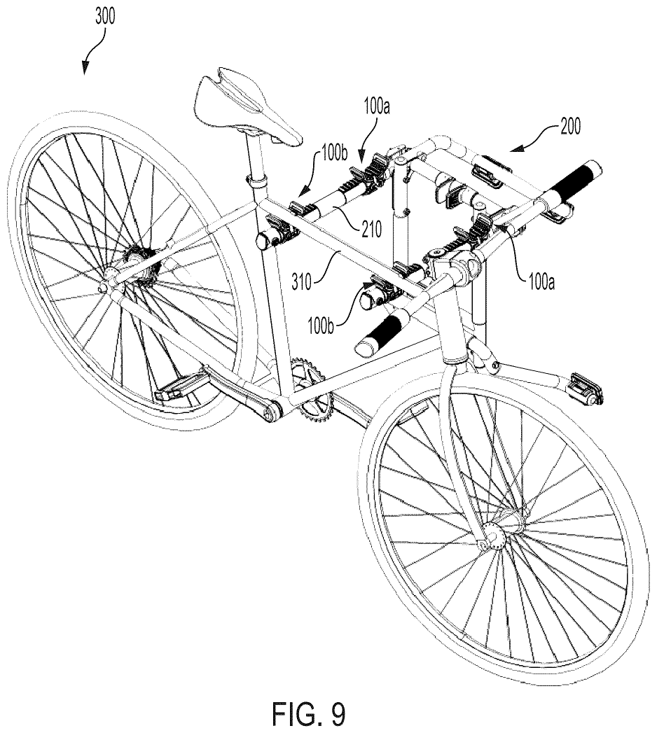

FIGS. 8 and 9 illustrate perspective views of a bicycle rack 200 according to one embodiment shown with a bicycle 300. As set forth above, and as described in the above-mentioned patents, the bicycle rack 200 is configured to hold the bicycle 300 to a vehicle (not shown). FIGS. 8 and 9 illustrate a bicycle 300 having a traditional frame design, where the substantially horizontally oriented bicycle frame tube 310 of the bicycle 300 is held by the two adjustable tie-down cradles 100b which includes the above-described first and second saddle components 20, 40. As shown in FIGS. 8 and 9, the first saddle component 20 can slide to adjust the size of the saddle to the bicycle frame tube 310. It should be appreciated that the two adjustable tie-down cradles 100a shown in FIGS. 8 and 9 may be used to hold a second bicycle (not shown) to the rack 200.

As mentioned above, the first and second saddle components 20, 40 can both move radially around the bicycle rack carrying arm 210 to adjust the angular orientation of the tie-down cradle 100 relative to the bicycle rack carrying arm 210. This feature is shown in FIG. 10-11 and may be beneficial for holding a bicycle 400 having a non-traditional frame design. FIG. 10 is a perspective view of a bicycle rack 200 according to one embodiment with a bicycle 400. As shown, the two adjustable tie-down cradles 100b of the bicycle rack 200 hold the bicycle 400, and the bicycle 400 includes a first bicycle frame tube 410, and a second bicycle frame tube 420. As shown, both tie-down cradles 100b (and associated first and second saddle components 20, 40) are moved radially around the bicycle rack carrying arm 210 to adjust the angular orientation of the tie-down cradle 100b relative to the bicycle rack carrying arm 210. In this particular embodiment, the first and second saddle components 20, 40 are each rotated counterclockwise relative to the original upright position (which is shown in the two adjacent tie-down cradles 100a). In one particular embodiment, the first and second saddle components 20, 40 may be moved between about 30°-about 90°, but other angles of rotation are also contemplated.

FIG. 11 illustrates the bicycle rack 200 shown in FIG. 10 but without the bicycle 400 to more clearly illustrate the radial movement of the first and second saddle components 20, 40. As shown, this radial movement of the first and second saddle components 20, 40 enables the bicycle rack 200 to be used with a wide variety of types and sizes of bicycles. Furthermore, it should be recognized that the radial movement of first and second saddle components 20, 40 of the tie-down cradle 100b proximate the handlebars of the bicycle 400 may be different than the radial movement of the first and second saddle components 20, 40 of the tie-down cradle 100b that is proximate the seat of the bicycle 400. However, in one embodiment, the radial movement of the first and second saddle components 20, 40 in both tie-down cradles 100b may be substantially the same. Additionally, the above-described distance D between the first and second saddle components 20, 40 of a first tie-down cradle 100b may be different than the distance D between the first and second saddle components 20, 40 of a second tie-down cradle 100b. In another embodiment, the distance D between the first and second saddle components 20, 40 in both tie-down cradles 100b may be substantially the same.

It should be recognized that in one embodiment, when the above-described locking mechanism is in an unlocked position, the angular/radial orientation of the elongated support member 60 and its first and second saddle components 20, 40 may be moved relative to the bicycle rack carrying arm 210 so that the overall position of the adjustable tie-down cradle is desirable for securing the bicycle to the carrying rack 200. Once in a desired position, the locking mechanism may be moved into a locked position so that the angular orientation of the elongated support member 60 and its first and second saddle components 20, 40 is fixed relative to the bicycle rack carrying arm 210.

As shown in the figures and in particular in FIGS. 5-7, in one embodiment, the first and second saddle components 20, 40 may each include a plurality of ridges 22, 42 configured to grip a bicycle frame tube 310, 410, 420 of a bicycle 300, 400. Furthermore, as shown in FIGS. 5-7, in one embodiment, the elongated support member 60 may also include a plurality of ridges 62 configured to grip a bicycle frame tube 310, 410, 420 of a bicycle 300, 400. As shown in FIG. 5, which shows a larger saddle 30 configuration with the first saddle component 20 spaced apart a distance D from the second saddle component 40, in one embodiment, the plurality of ridges 62 on the elongated support member 60 may form the center portion of the saddle 30. Furthermore, as shown in FIGS. 6 and 7, in one embodiment, where the second saddle component 40 is integrally molded with the elongated support member 60, the plurality of ridges 42 on the second saddle component 40 may be integrally formed with the plurality of ridges 62 on the elongated support member 60.

As shown in FIGS. 6-7, in one embodiment, the first saddle component 20 may include an opening 24 therethrough, and the second saddle component 40 may also include an opening 44 therethrough. As discussed in Applicant's above-mentioned earlier patents, which are all incorporated by reference in in their entirety, in one embodiment, one or more straps (not shown in the attached figures) may be provided to secure a bicycle frame tube 310, 410, 420 to each cradle 100a, 100b. In one embodiment, the strap may be thread through one or both of the openings 24, 44 to enable the strap to be secured to each of the first and second saddle components 20, 40. The strap may be tightened around the bicycle frame tube to help secure the bicycle 300, 400 to the rack 200.

As mentioned above, in one illustrative embodiment, the second saddle component 40 is integrally molded with the elongated support member 60. In another embodiment, it is contemplated that the second saddle component 40 is formed separately from the elongated support member 60, and the second saddle component may slide linearly along the first axis 110 of the elongated support member 60 to adjust the overall size of the saddle. It should be recognized that in this embodiment, a locking mechanism may be configured to lock the position of the second saddle component 40 relative to the elongated support member 60, and for example, a second locking mechanism may be provided to secure the position of the second saddle component 40.

The present disclosure also contemplates methods of adjusting a tie-down cradle 100 on a vehicle bicycle rack 200. For example, the method may include providing a bicycle rack 200 having a bicycle rack carrying arm 210 and providing an adjustable tie-down cradle 100 on the bicycle rack carrying arm 210. The adjustable tie-down cradle 100 may include an elongated support member 60 having a first axis 110, and a saddle 30 configured to hold a bicycle frame tube 310, 410, 420 of a bicycle 300, 400. The saddle 30 may include a first saddle component 20 coupled to the elongated support member 60, and a second saddle component 40 coupled to the elongated support member 60. The method may include sliding the first saddle component 20 linearly along the first axis 110 of the elongated support member 60 to adjust the size of the saddle 60 to a bicycle frame tube 310, 410, 420. The method may also include rotating the first and second saddle components 20, 40 radially around the bicycle rack carrying arm 210 to adjust the angular orientation of the tie-down cradle 100a, 100b relative to the bicycle rack carrying arm 210.

As mentioned above, in one embodiment, the second saddle component 40 is integrally molded to the elongated support member 60. However, it should be appreciated that in another embodiment, the second saddle component 40 may be formed separately from the elongated support member 60, and the second saddle component 40 may be selectively movable relative to the elongated support member 60. Accordingly, in one embodiment, the method may further include sliding the second saddle component 40 linearly along the first axis 110 of the elongated support member 60 to adjust the size of the saddle 30 to a bicycle.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

What is claimed is:

1. A bicycle rack configured to hold a bicycle to a vehicle, the bicycle rack comprising:
a bicycle rack carrying arm;
an adjustable tie-down cradle coupled to the bicycle rack carrying arm, the adjustable tie-down cradle comprising:
an elongated support member slidably received on the bicycle rack carrying arm, the elongated support member having a first axis;
a saddle configured to hold a bicycle frame tube of a bicycle, the saddle comprising:
a first saddle component coupled to the elongated support member; and
a second saddle component coupled to the elongated support member;
wherein the first saddle component can slide linearly along the first axis of the elongated support member to adjust the size of the saddle to a bicycle frame tube; and
wherein the first and second saddle components can both move radially around the bicycle rack carrying arm to adjust the angular orientation of the tie-down cradle relative to the bicycle rack carrying arm.

2. The bicycle rack of claim 1, wherein the elongated support member is a cylindrical shaped tube.

3. The bicycle rack of claim 1, wherein the first saddle component and the second saddle component together form a substantially C-shaped saddle shaped to hold a bicycle frame tube of a bicycle.

4. The bicycle rack of claim 1, wherein the second saddle component is integrally molded with the elongated support member.

5. The bicycle rack of claim 1, wherein the second saddle component can slide linearly along the first axis of the elongated support member to adjust the overall size of the saddle.

6. The bicycle rack of claim 1, further comprising a locking mechanism on the elongated support member, wherein the locking mechanism is configured to lock the position of the first saddle component relative to the elongated support member.

7. The bicycle rack of claim 1, wherein the first and second saddle components each comprises a plurality of ridges configured to grip a bicycle frame tube of a bicycle.

8. The bicycle rack of claim 7, wherein the elongated support member comprises a plurality of ridges configured to grip a bicycle frame tube of a bicycle.

9. An adjustable tie-down cradle for use with a vehicle bicycle rack, comprising:
an elongated support member having a first axis, wherein the elongated support member is configured to be slidably received on a bicycle rack carrying arm of a bicycle rack;
a saddle configured to hold a bicycle frame tube of a bicycle, the saddle comprising:
a first saddle component coupled to the elongated support member; and
a second saddle component coupled to the elongated support member;
wherein the first saddle component can slide linearly along the first axis of the elongated support member to adjust the size of the saddle to a bicycle frame tube; and
wherein the second saddle component is integrally molded to the elongated support member.

10. The adjustable tie-down cradle of claim 9, wherein the elongated support member is a cylindrical shaped tube.

11. The adjustable tie-down cradle of claim 9, wherein the first saddle component and the second saddle component together form a substantially C-shaped saddle shaped to hold a bicycle frame tube of a bicycle.

12. The adjustable tie-down cradle of claim 9, in combination with a bicycle rack configured to be coupled to a vehicle, the bicycle rack comprising a bicycle rack carrying arm, wherein the elongated support member is slidably received on the bicycle rack carrying arm; and
wherein the first and second saddle components can both move radially around the bicycle rack carrying arm to adjust the angular orientation of the tie-down cradle relative to the bicycle rack carrying arm.

13. The adjustable tie-down cradle of claim 9, further comprising a locking mechanism on the elongated support member, wherein the locking mechanism is configured to lock the position of the first saddle component relative to the elongated support member.

14. The adjustable tie-down cradle of claim 9, wherein the first and second saddle components each comprises a plurality of ridges configured to grip a bicycle frame tube of a bicycle.

15. The adjustable tie-down cradle of claim 14, wherein the elongated support member comprises a plurality of ridges configured to grip a bicycle frame tube of a bicycle.

16. A method of adjusting a tie-down cradle on a vehicle bicycle rack comprising:
providing a bicycle rack comprising a bicycle rack carrying arm;
providing an adjustable tie-down cradle on the bicycle rack carrying arm, the adjustable tie-down cradle comprising:
an elongated support member having a first axis;
a saddle configured to hold a bicycle frame tube of a bicycle, the saddle comprising:
a first saddle component coupled to the elongated support member; and
a second saddle component coupled to the elongated support member;
sliding the first saddle component linearly along the first axis of the elongated support member to adjust the size of the saddle to a bicycle frame tube;
rotating the first and second saddle components radially around the bicycle rack carrying arm to adjust the angular orientation of the tie-down cradle relative to the bicycle rack carrying arm.

17. The method of claim 16, further comprising:
sliding the second saddle component linearly along the first axis of the elongated support member to adjust the size of the saddle to a bicycle.
